(19) United States
(12) Patent Application Publication
(10) Pub. No.: US 2012/0036447 A1
(43) Pub. Date: Feb. 9, 2012

(54) JOB PROCESSING APPARATUS AND CONTROL METHOD FOR THE JOB PROCESSING APPARATUS

(75) Inventor: Kaori Nishiyama, Tokyo (JP)

(73) Assignee: CANON KABUSHIKI KAISHA, Tokyo (JP)

(21) Appl. No.: 13/185,209

(22) Filed: Jul. 18, 2011

(30) Foreign Application Priority Data
Aug. 3, 2010 (JP) 2010-174566

(51) Int. Cl. G06F 3/048; G06F 15/16; G06F 21/20

(52) U.S. Cl. 715/741; 715/772

(57) ABSTRACT

A job processing apparatus for performing a job process for a job input by a user includes a job determination unit configured to determine whether there is a job being executed or waiting to be executed for a user when the user logs into the job processing apparatus, and a job status display control unit configured to display a job execution information screen showing an execution status of the job being executed or waiting to be executed for the user when it is determined by the job determination unit that there is the job being executed or waiting to be executed.

### BACKGROUND OF THE INVENTION

1. Field of the Invention

The present invention relates to a job processing apparatus and a control method for the job processing apparatus, and particularly relates to job management and screen display control in a job processing apparatus including a plurality of processing functions.

2. Description of the Related Art

As a job processing apparatus with a plurality of processing functions, a digital multifunction peripheral is well known. The included processing functions are typically copying, printing, scanning, e-mail transmission, and facsimile transmission and reception, for example. Moreover, the digital multifunction peripheral is also capable of processing functions to store digital data in and call digital data from a storage device.

In a digital multifunction peripheral, a plurality of types of jobs can be input. If a j ob has been input by mistake, it is sometimes difficult to immediately select this job from a list of jobs and stop it. For example, it is difficult to stop a job when it has been input to a digital multifunction peripheral via a network from a place far away from the digital multifunction peripheral.

While a user inputs a job, if the user needs to make a job reservation or if there is a job to be executed at a time set on a timer, it is difficult to stop the job. In such cases, for example, if a job execution screen is not displayed while a job is being executed or if the screen has been closed, it is not possible to select a job to be stopped from a job list and stop the job.

To prevent this inconvenience, for example, there is a digital multifunction peripheral which is configured to issue a job ID when a user inputs a job. When a user wants to stop the job, the user can stop the job by inputting a job ID to the digital multifunction peripheral (Japanese Patent Application Laid-Open No. 10-233862, for example).

If a job ID is issued when a user reserves a job, the user needs to remember the job ID. Therefore, when the user makes two or more job reservations, the user needs to remember a plurality of job IDs in association with the respective jobs. Thus, it is sometimes difficult for the user to grasp a number of job IDs and reserved jobs.

If a user makes an error in inputting a job ID, this may cause control, such as temporary stop, to be effective even on others' jobs. Under such circumstances, the efficiency of a job process may be reduced to an extent corresponding to a temporary stop of the job.

Moreover, problems arise even after the end of job execution. For example, if a print job has been put into the digital multifunction peripheral but it is not output, nobody knows if someone carried away printed products by mistake or if the print job ended abnormally. Therefore, it is necessary for the user to select his job from the job history and investigate detailed information.

With regard to the image processing apparatus, such as a digital multifunction peripheral, users may have the following requests: One request is that it should be made possible to immediately stop the job when it was input by mistake and another request is that, when a job ended abnormally, the user wants to know if this is abnormal ending or not. In other words, with conventional image processing apparatuses, it is difficult to meet these two requests, and it is difficult to easily grasp the status of a job input by the user.

### SUMMARY OF THE INVENTION

One aspect of the present invention is directed to a job processing apparatus capable of allowing a user to easily grasp the status of a job input by the user, and also directed to a control method for the job processing apparatus.

According to another aspect of the present invention, a job processing apparatus for performing a job process for a job input by a user includes a job determination unit configured to determine whether there is a job being executed or waiting to be executed for a user when the user logs into the job processing apparatus, and a job status display control unit configured to display a job execution information screen showing an execution status of the job being executed or waiting to be executed for the user when it is determined by the job determination unit that there is the job being executed or waiting to be executed.

According to another aspect of the present invention, when a user logs into a job processing apparatus, if there is a job being executed or waiting to be executed, the job processing apparatus displays a job execution information screen showing an execution status of the job being executed or waiting to be executed. Thus, the user can instantly notice the execution status of the job which was input by the user. Therefore, a user, who wants to stop or temporarily stop the execution of the job, need not search a job list for his own job and can immediately execute an execution stop process via the job execution information screen.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a hardware configuration of an image processing apparatus as a job processing apparatus according to an exemplary embodiment of the present invention.

FIG. 2 is a block diagram illustrating an example of a configuration of a network system connected to the image processing apparatus illustrated in FIG. 1.

FIG. 3 is a block diagram illustrating an example of a hardware configuration of each personal computer (PC) illustrated in FIG. 2.

FIG. 4 is a block diagram illustrating an example of functions of the image processing apparatus illustrated in FIG. 1.

FIG. 5 is a block diagram illustrating an example of functions of the PC illustrated in FIG. 2.

FIG. 6 is a flowchart illustrating a process to be executed when a print job is input from the PC illustrated in FIG. 2 into the image processing apparatus.

FIG. 7A is a flowchart illustrating a display process to be executed in the image processing apparatus illustrated in FIG. 1.

FIG. 7B is a flowchart for a display process to be executed in the image processing apparatus illustrated in FIG. 1.

FIG. 8 is a diagram illustrating an example of an abnormally-ended job history information display screen displayed on an operation panel illustrated in FIG. 1.

FIG. 9 is a diagram illustrating an example of a job execution information display screen displayed on the operation panel illustrated in FIG. 1.

FIG. 10 is a diagram illustrating an example of a job execution information display screen displayed on the operation panel illustrated in FIG. 1.

FIG. 11 is a diagram illustrating an example of a job execution information display screen displayed on the operation panel illustrated in FIG. 1.

### DETAILED DESCRIPTION OF THE EMBODIMENTS

Various exemplary embodiments, features, and aspects of the invention will be described in detail below with reference to the drawings.

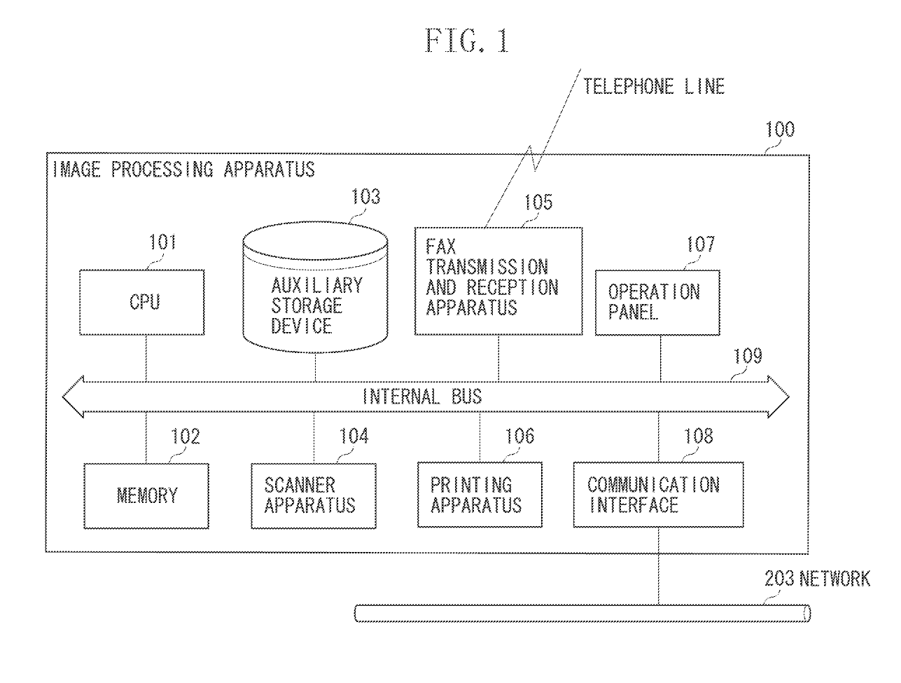

FIG. 1 is a block diagram illustrating an example of a hardware configuration of an image processing apparatus 100 as a job processing apparatus according to an exemplary embodiment of the present invention.

As illustrated in FIG. 1, an image processing apparatus 100 includes a central processing unit (CPU) 101, a memory 102, an auxiliary storage device 103, a scanner apparatus 104, a facsimile (fax) transmission and reception apparatus 105, a printing apparatus 106, an operation panel 107, and a communication interface 108, which are mutually interconnected by an internal bus 109.

The CPU 101 controls the entire image processing apparatus. The memory 102 includes a random access memory (RAM) section and a read-only memory (ROM), and can store various kinds of data and a program. The auxiliary storage device 103 is a large-capacity storage device, such as a hard disk or a solid state drive (SSD). The auxiliary storage device 103 can hold large amounts of data and program execution code. The auxiliary storage device 103 stores data which needs to be retained for a longer time than in the memory 102.

The scanner apparatus 104 optically scans a document and reads an image of the document, for example. The fax transmission and reception apparatus 105 is connected to a telephone line and transmits and receives fax documents. The printing apparatus 106 perform printing by an electrophotographic process, for example. More specifically, the printing apparatus 106 prints digital image data on a paper medium by using toner. The printing apparatus 106 may be an ink printer. The operation panel 107 provides (displays) various types of information for the user. The user inputs commands via the operation panel 107. The communication interface 108 handles transmission and reception of digital data via a network 203. In other words, the communication interface 108 performs e-main transmission, service message block (SMB) transmission, and transmission and reception of information necessary for the image processing apparatus.

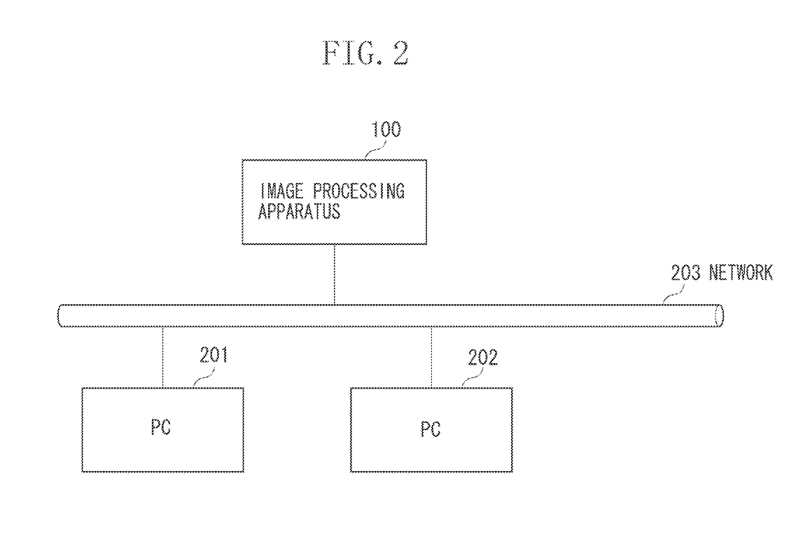

FIG. 2 is a block diagram illustrating an example of a configuration of a network system connected to the image processing apparatus 100 illustrated in FIG. 1.

In the example illustrated in FIG. 2, personal computers (PC) 201 and 202 are connected to the image processing apparatus 100 via the network 203. In this example, two PCs 201 and 202 are used, but a plurality of PCs may be connected to the network 203 and the PC 201 serves as a server.

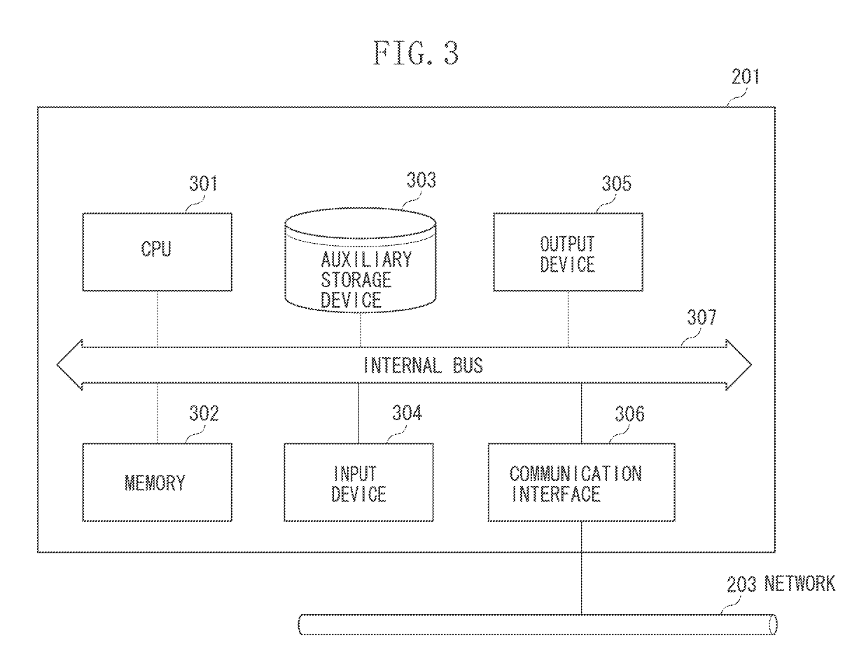

FIG. 3 is a block diagram illustrating an example of the hardware configuration of each of the PC 201 and PC 202 illustrated in FIG. 2.

Referring to FIG. 3, the hardware configuration of the PC 201 only will be described because the hardware configuration is common to the PC 201 and the PC 202.

The PC 201 includes a CPU 301, a memory 302, an auxiliary storage device 303, an input device 304, an output device 305, and a communication interface 306, which are all mutually interconnected by an internal bus 307.

The CPU 301 controls the entire PC 201. The memory 102 includes a RAM and a ROM, and can store various kinds of data and a program. The auxiliary storage device 103 is a large-capacity storage device, such as a hard disk. The auxiliary storage device 103 can hold large amounts of data and program execution codes. The auxiliary storage device 103 stores data which needs to be retained for a longer time than in the memory 102.

The input device 304 is a keyboard or a pointing device, for example. The user inputs various commands on the input device 304 to send them to the PC 201. The output device 305 is a display, for example, which shows information about a process by the CPU 301. The communication interface 306 handles transmission and reception of digital data via the network 203.

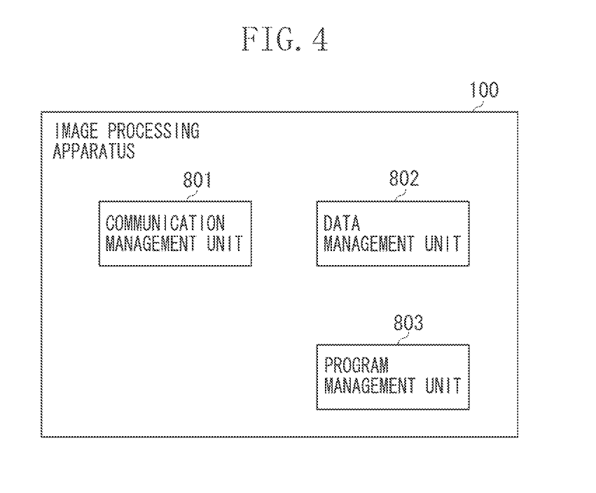

FIG. 4 is a block diagram illustrating an example of functions of the image processing apparatus 100 illustrated in FIG. 1. The functions illustrated in FIG. 4 are realized when the CPU 101 executes a program stored in the memory 102 in the image processing apparatus 100.

As illustrated in FIG. 4, in this example, the image processing apparatus 100 includes functions, such as a communication management unit 801, a data management unit 802, and a program management unit 803.

The communication management unit 801 analyzes communication commands transmitted and received via the communication interface 108, and controls the communication operations. The data management unit 802 manages various kinds of data handled in the image processing apparatus 100. The program management unit 803 controls and manages the execution of resident and transient commands managed by the data management unit 802.

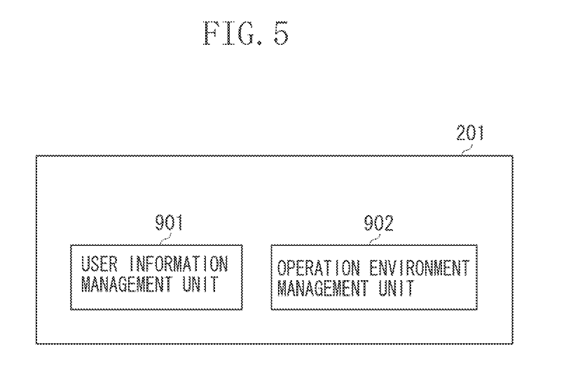

FIG. 5 is a block diagram illustrating an example of the functions of the PC 201 illustrated in FIG. 2. The functions illustrated in FIG. 5 are realized when the CPU 301 executes the program stored in the memory 302 in the PC 201.

The PC 201 illustrated in FIG. 5 is a user authentication server, for example, and the PC 201 includes, as its functions, a user information management unit 901 and an operation environment management unit 902.

The user information management unit 901 manages user information used to authenticate a user in response to an authentication request via the communication interface 306 from a terminal (a PC, for example) connected to the network 203. The operation environment management unit 902 manages an operation environments of individual users managed in the user information management unit 901. In the present exemplary embodiment, the user information management unit 901 manages information used to customize, for individual users, an operation screen displayed on the operation panel 107, for example. It becomes possible to provide each user with an easy-to-use operation screen by displaying an operation screen on the operation panel 107 based on operation environment information when the user logs into the image processing apparatus 100.

In the present exemplary embodiment, the operation environment management unit 902 manages the operation environments for the individual users who are managed by the user information management unit 901. However, the operation environment management unit 902 may manage the operation environment of the image processing apparatus 100. Moreover, in the present exemplary embodiment, the PC 201 serving as a user authentication server includes the user information management unit 901 and the operation environment management 902, but at least either the user information management unit 901 or the operation environment management unit 902 may be included in the image processing apparatus 100.

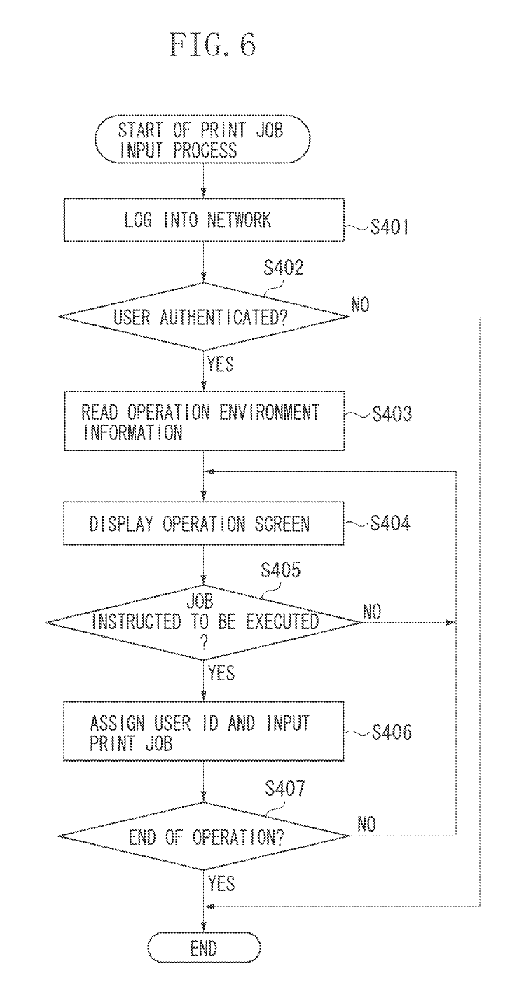

FIG. 6 is a flowchart illustrating a process performed when a print job is input from the PC 202 into the image processing apparatus 100 illustrated in FIG. 2.

As can be seen from FIGS. 2, 3 and 6, when the PC 202 inputs a print job into the image processing apparatus 100, then in step S401, via the input device 304 of the PC 202, the user logs into the user authentication server 201 by inputting user information by which to identify the user (network login process). By this operation, the CPU 301 (user information management unit 901) supplies the user authentication server 201 with user information via the communication interface 306. In the user authentication server 201, the CPU 301 performs authentication check on the user according to the user information, and supplies the PC 202 with user authentication information regarding whether the authentication is successful.

In step S402, in the PC 202, the CPU 301 (the user information management unit 901) confirms if the user was authenticated by the user authentication server 201 based on the user authentication information. If the authentication is not successful (NO in step S402), the CPU 301 displays an authentication failure message on the output device 305, and ends the process.

On the other hand, when the authentication is successful (YES in step S402), then in step S403, the CPU 301 (the operation environment management unit 902) in the PC 202 obtains operation environment information corresponding to the user information from the user authentication server 201. In step S404, the CPU 301 (the operation information management unit 902) displays an operation screen on the output device 305.

In step S405, the CPU 301 of the PC 202 monitors the operation to determine whether a command has been issued to execute a print job (this command to execute a print job is issued by a prescribed operation performed on the operation screen). If a command to execute a print job has not been issued (NO in step S405), the CPU 301 returns to step S404, and performs the operation in step S404.

When a command to execute a print job is issued (YES in step S405), then in step S406, the CPU 301 assigns a user ID (identification code) to the print job and inputs the print job to the image processing apparatus 100 (transmits print data to the image processing apparatus 100). When obtaining the print job, the image processing apparatus 100 executes a print process (print job) based on the print data received. Then, in step S407, the CPU 301 in the PC 202 monitors the operation to determine whether a command to end the operation has been received from the input device 304. If a command to end the operation has not been received (NO in step S407), the CPU 301 returns to step 404 and performs the operation in step S404. On the other hand, if a command to end the operation has been received (YES in step S407), the CPU 301 performs a log-out process and ends the series of the processes.

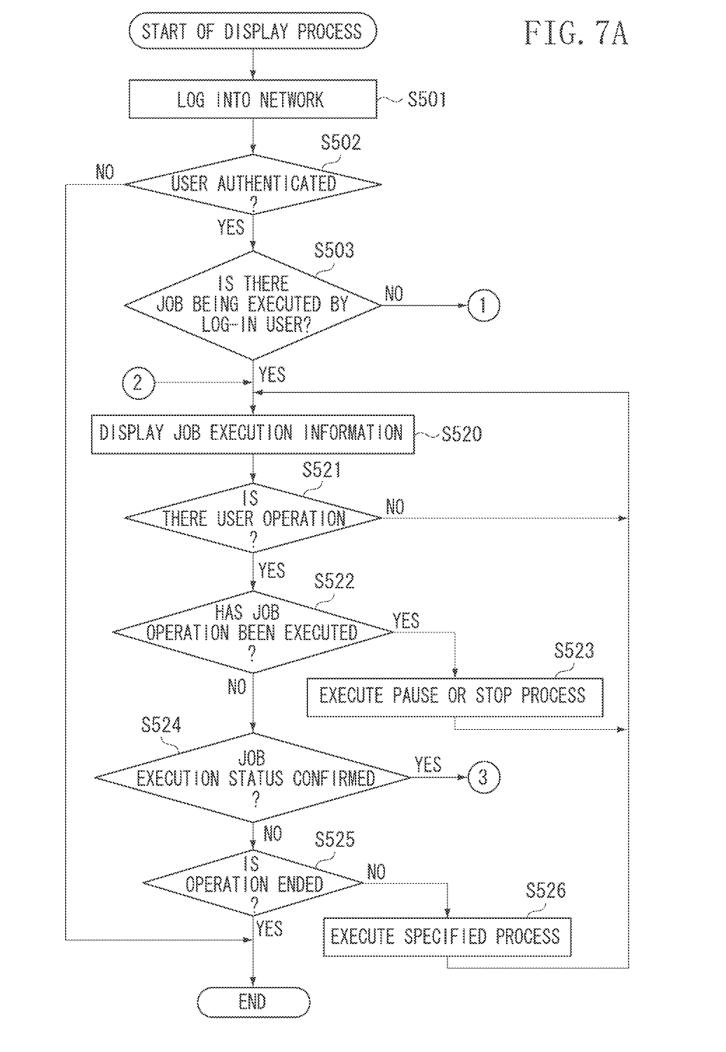

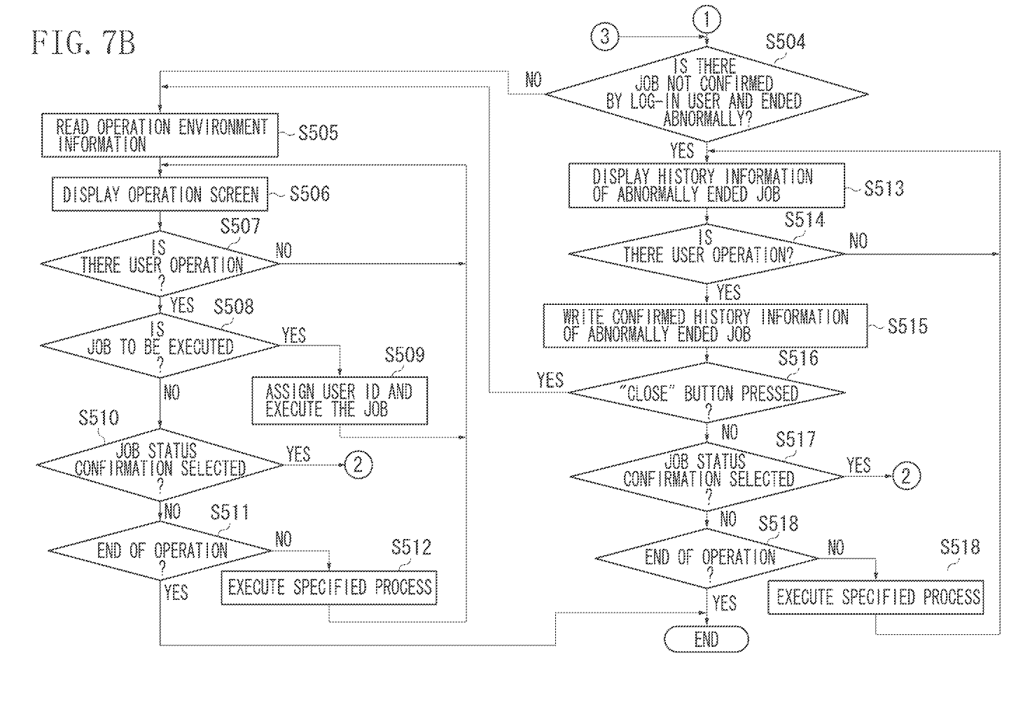

FIGS. 7A and 7B are flowcharts illustrating a display process to be executed by the image processing apparatus 100 in FIG. 1.

Referring to FIGS. 1, 2, 7A, and 7B, the operations in the image processing apparatus will be described. In the image processing apparatus 100, in step S501, when user information is received from the operation panel 107, the CPU 101 (the communication management unit 801) sends the user information to the user authentication server 201 via the communication interface 108 to execute a network log-in process. In other words, in the user authentication server 201, the CPU 301 performs user authentication based on the user information, and supplies the image processing apparatus 100 with user authentication information regarding whether authentication is successful.

In the image processing apparatus 100, in step S502, the CPU 101 confirms if the user was authenticated by the user authentication server 201 based on the user authentication information. If the authentication is unsuccessful (NO in step S502), the CPU 101 displays a failure message of authentication on the operation panel 107.

On the other hand, if the authentication is successful (YES in step S502), then in step S503, the CPU 101 determines whether there is a job being executed or waiting to be executed in response to an instruction from a logged-in user. If the determination is NO in step S503, the CPU 101 (the data management unit 802) determines whether there is a job which the logged-in user has not confirmed and which ended without being executed or whether there is a job ended abnormally. The abnormally ended job refers to a job that did not end normally because an error occurred in the image processing apparatus 100 when some job was being executed or was waiting for execution.

If the determination is NO in step S504, then in step S505, the CPU 101 obtains operation environment information corresponding to the logged-in user from the user authentication server 201. Then, in step S506, the CPU 101 displays an operation screen on the operation panel 107 based on the operation environment information.

Then, in step S507, the CPU 101 determines whether a user's operation has been performed on the operation screen displayed on the operation panel 107. If a user's operation has not been performed (NO in step S507), the CPU 101 returns to step S506.

If the user has performed some operation on the operation panel 107 (YES in step S507), then in step S508, the CPU 101 determines whether the operation performed by the user is a job execution operation. If the operation performed is the job execution operation (YES in step S508), then in step S509, the CPU 101 assigns a user ID to the job and inputs the job. Then, the CPU 101 returns to step S506, and displays an operation screen on the operation panel 107, such as a job execution screen.

On the other hand, if the operation is not the job execution operation (NO in step S508), then in step S510, the CPU 101 determines whether job status confirmation is selected on the operation screen. A Job Status Confirm button (not illustrated) is provided on the operation panel 107, which is usable to determine the job status.

When the job status confirmation is selected (YES in step S510), the CPU 101 proceeds to step S520, which will be described below. If the job status confirmation is not selected (NO in step S510), then in step S511, the CPU 101 determines whether an operation ending process has been performed.

If the operation is not ended (NO in step S511), then in step S512, the CPU 101 executes a previously specified process, such as display of a setting screen. Then, the CPU 101 returns to step S506 to display an operation screen. On the other hand, if the operation is ended (YES in step S511), the CPU 101 performs a log-out process to end the series of processes.

In step S504, if there is a job which the logged-in user has not confirmed and which ended without being executed (YES in step S504), then in step S513, the CPU 101 causes the operation panel 107 to display history information of the abnormally-ended job.

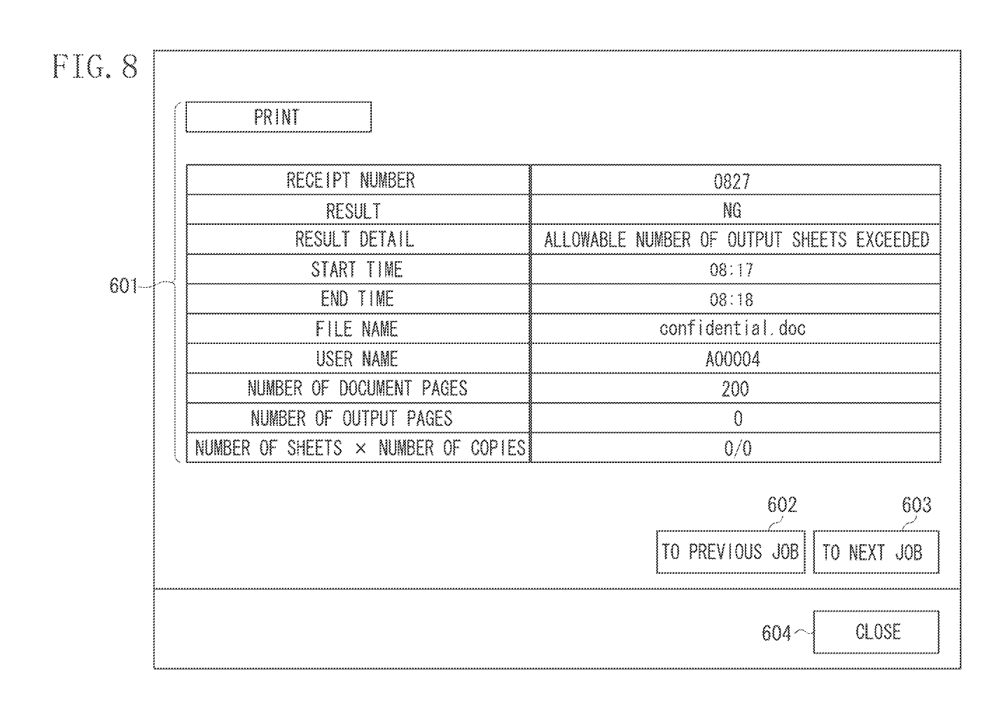

FIG. 8 illustrates an example of a display screen of history information of the abnormally-ended job (an abnormally-ended job history information display screen) on the operation panel 107 in FIG. 1.

In FIG. 8, the abnormally-ended job history information display screen (an abnormally-ended job detail screen) shows a job history detail information list 601. The job history detail information list 601 includes a job type, job receipt number, result, result detail, job start time, job end time, file name, user name, number of document pages, number of output pages, and number of sheets set by number of copies set.

The abnormally-ended job history information display screen displays a “To Previous Job” button 602 and a “To Next Job” button 603, and also a “Close” button 604. When the “To Previous Job” 602 button is pressed, the CPU 101 displays the job history detail information list 601 about a logged-in user of the previous abnormally-ended job.

When the “To Next Job” button 603 is pressed, the CPU 101 displays the job history detail information list 601 about a logged-in user of the next abnormally-ended job. When the “Close” button is 604 is pressed, the CPU 101 closes the abnormally-ended job history information display screen.

The abnormally-ended job history information display screen illustrated in FIG. 8 presents a case where there is not a job being executed for a user with the user name of “A0004” but there is an abnormally-ended job. This screen is displayed when the user logs in.

If an abnormally-ended job is displayed when a user logs in, the user need not look for a job to output, nor does he need to input the job again. The user can obtain necessary information without searching for a result of his ended job from a list of job history information.

Then, in step S514, the CPU 101 determines whether a user's operation has been performed on the abnormally-ended job history information display screen. If no user's operation has been performed (NO in step S514), the CPU 101 returns to step S513.

On the other hand, if a user's operation has been performed (YES in step S514), the CPU 101 determines that the abnormally ended job history has been confirmed and rewrites the displayed abnormally-ended job history to confirmed information. Accordingly, the CPU 101 does not display the abnormally-ended job history when the user logs in next time.

Then, in step S516, the CPU 101 determines on the abnormally-ended job history information display screen whether the “Close” button 604 has been operated. If the “Close” button 604 has been operated (YES in step S516), the CPU 101 closes the abnormally-ended job history information display screen, and proceeds to step S505.

If a user's operation has been performed but the “Close” button 604 has not been operated (NO in step S516), then in step S517, the CPU 101 determines whether the job status confirmation has been selected.

If the job status confirmation has been selected (YES in step S517), the CPU 101 proceeds to step S520, which will be described below. If the job status confirmation has not been selected (NO in step S517), then in step S518, the CPU 101 determines whether an operation stop process has been performed.

If the operation stop process has not been performed (NO in step S518), then in step S519, the CPU 101 executes a previously specified process, such as displaying a previous abnormally-ended job or a next abnormally-ended job. Then, the CPU 101 returns to step S513 to display the abnormally-ended job history information display screen. On the other hand, if operation stop process has been performed (YES in step S518), the CPU 101 executes a log-out process and ends the series of processes.

If there is a logged-in user's job being executed in step S503 (YES in step S503), then in step S520, the CPU 101 (the data management unit 802) displays job execution information on the operation panel 107.

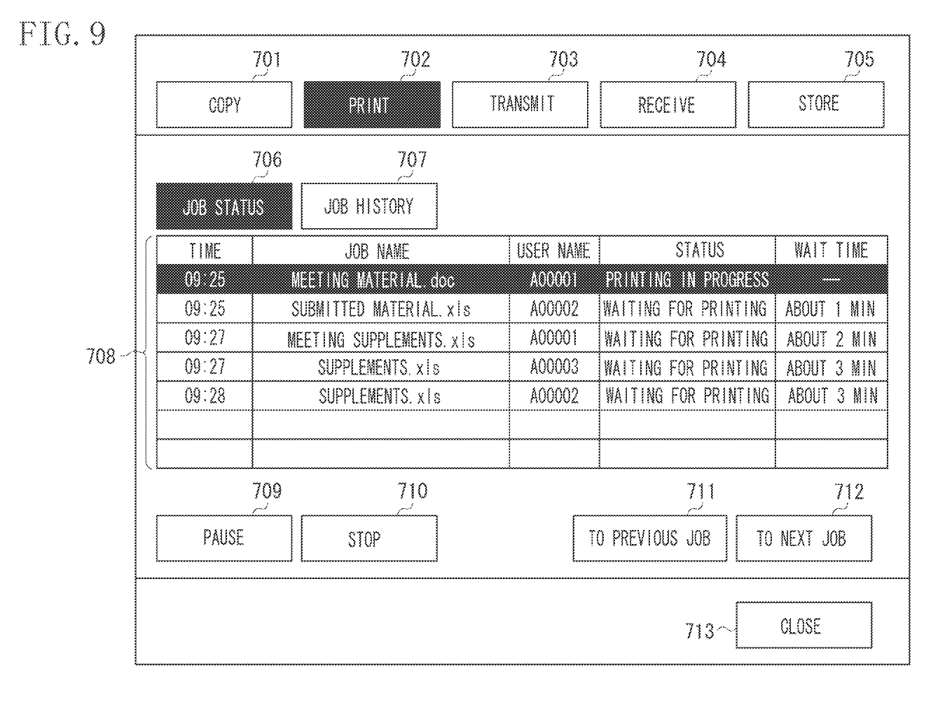

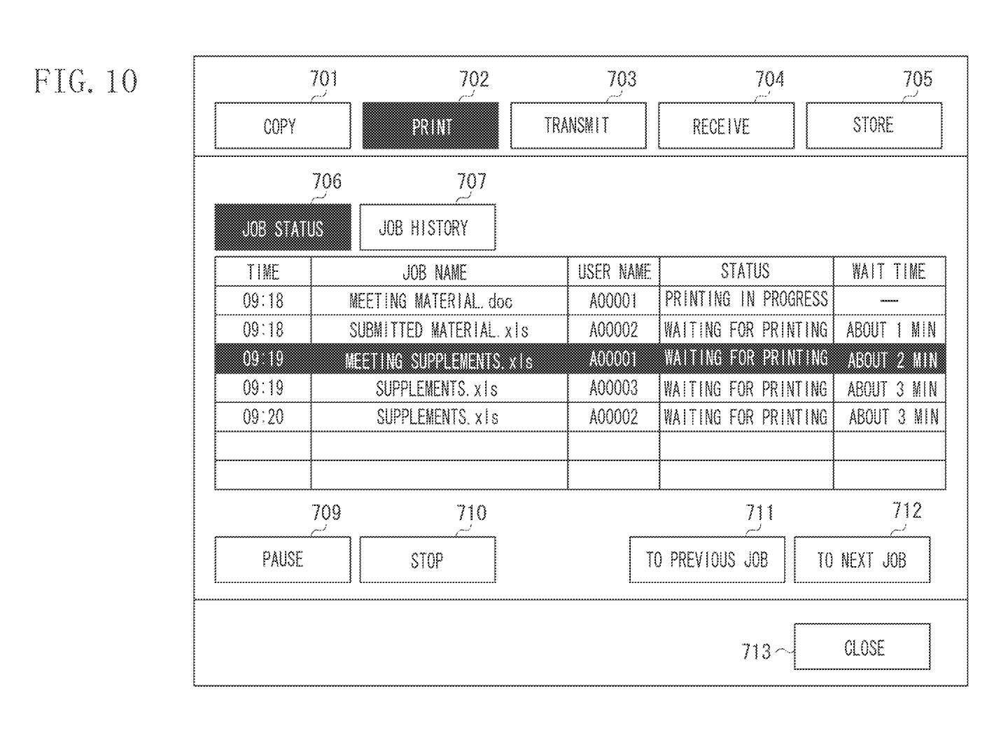

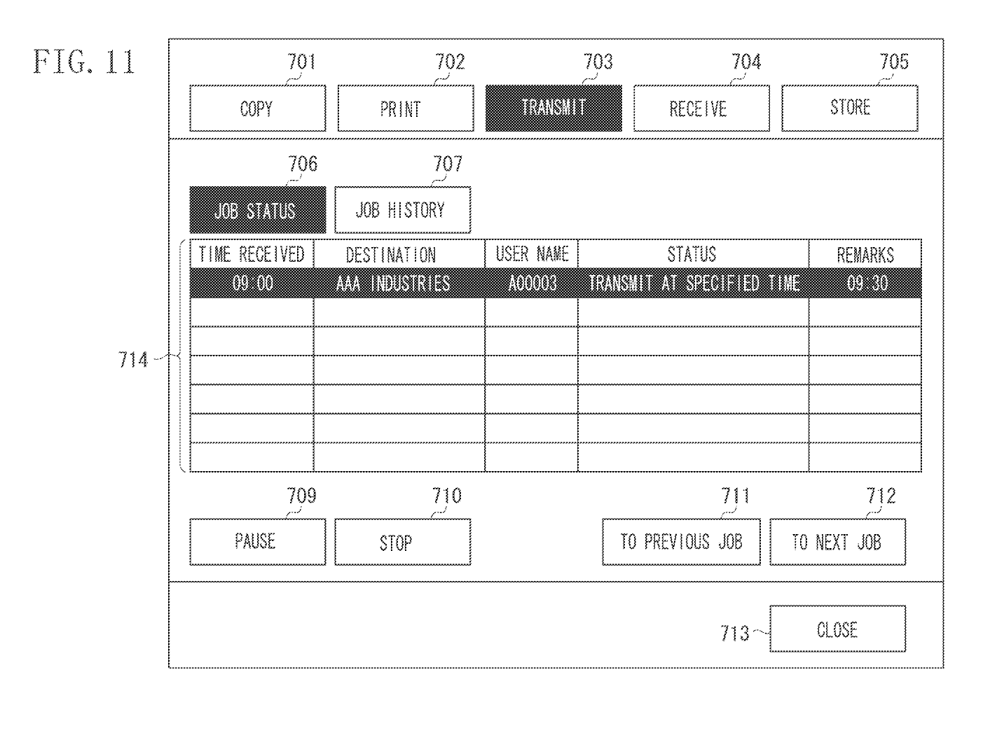

FIG. 9 is a diagram illustrating an example of a job execution information display screen displayed on the operation panel 107 illustrated in FIG. 1. FIG. 10 is a diagram illustrating an example of a job execution information display screen displayed on the operation panel 107 displayed in FIG. 1. FIG. 11 is a diagram illustrating an example of a job execution information display screen displayed on the operation panel 107 displayed in FIG. 1.

When a Copy button 701 is operated on the job execution information display screen illustrated in FIG. 9, the CPU 101 displays the status and history of a copy job on the operation panel 107. When a Print button 702 is pressed, the CPU 101 displays the status and history of a print job on the operation panel 107. When a Transmit button 703 is operated, the CPU 101 displays the status and history of a transmission job, such as fax, e-mail, or SMB transmission, on the operation panel 107.

When a Receive button 704 is operated, the CPU 101 displays the status and history of a reception job, such as fax and Internet-fax (IFAX) reception, on the operation panel 107. When a Store button 705 is pressed, the CPU 101 displays the status and history of a storing job, such as storing data in a memory medium or a server, on the operation panel 107.

When a Job Status button 706 is operated, the CPU 101 displays the status of a job being executed or waiting to be executed on the operation panel 107. When a Job History button 707 is operated, the CPU 101 displays the history of an executed job on the operation panel 107.

In the example illustrated in FIG. 9, the Print button 702 and the Job Status button 706 are selected or operated. Thus, a print job status list 708 is displayed on the operation panel 107 to show the statuses of print jobs.

The print job status list 708 indicates times at which the jobs were received, job names of the jobs which were input, their execution statuses, and wait times until their execution.

When a Pause button 709 is operated, the CPU 101 temporarily stops the execution of the currently selected job. When a Stop button 710 is operated, the CPU 101 stops the currently selected job. When a “To Previous Job” button 711 is operated, the CPU 101 displays the previous job which was being executed or waiting to be executed on the operation panel 107. When a “To Next Job” button 712 is operated, the CPU 101 displays the next job waiting to be executed on the operation panel 107. When a “Close” button 713 is operated, the CPU 101 closes the job execution information display screen.

The example illustrated in FIG. 9 is a screen displayed when a user with the user name of “A00001” has logged in. In this screen, the job currently being executed (printing in progress) is selected. Under this condition, when the Pause button 709 is pressed, the CPU 101 temporarily stops the execution of the current job. When the Stop button 710 is pressed, the CPU 101 stops the job.

Since the example illustrated in FIG. 9 indicates a screen displayed when the user has logged in, it is impossible to operate the “To Previous Job” button 711. On the other hand, when the “To Next Job” button 712 is operated, as illustrated in FIG. 10, the CPU 101 selects a next job waiting to be executed, which was input by a user with the user name of “A00001”.

The example illustrated in FIG. 11 indicates a job execution information display screen displayed when a user with the user name of “A00003” has logged in. In this screen, since the Transmit button 703 and the Job Status button 706 are selected, the status of the transmission job is displayed in a job list (transmission job status list) 714. The transmission job status list 714 includes times when jobs were received, transmission destinations, user names of users who input jobs, execution statuses, and remarks.

In FIG. 9, for a user with the user name of “A0003”, there is a print job waiting for printing. Meanwhile, since transmission jobs take shorter time until their execution than print jobs, transmission jobs are displayed in preference to print jobs

When there is a job being executed or waiting to be executed, job execution information associated with users (in other words, job execution status) is displayed to inform the user of an execution status of his own job. Therefore, it is possible for the user to control stop and temporary suspension of execution, and perform processing without searching a job execution list for his own job.

Referring back to FIGS. 1, 2, 7A, and 7B, after displaying the job execution information display screen as described above, in step S521, the CPU 101 determines whether a user's operation has been performed. If the user's operation has not been performed (NO in step S521), the CPU 101 returns to step S510 to display job execution information.

If the user's operation has been performed (YES in step S521), then in step S522, the CPU 101 determines whether a job operation has been executed. If the job operation has been performed (YES in step S522), then in step S523, the CPU 101 executes a process, such as a temporary stop (pause) or stop process. Then, the CPU returns to step S520 to update the job execution information display screen.

If the user's operation has been performed but this operation is not a job operation (NO instep S522), then in step S524, the CPU 101 determines whether a job execution status has been confirmed, which includes confirmation of the operation of the “Close” button 713. If the above confirmation has been completed (YES in step S524), the CPU 101 proceeds to step S504 to determine whether there is a job which has not been confirmed by the user and abnormally ended.

If the user's operation has been performed but the above confirmation has not been completed (NO in step S524), then in step S525, the CPU 101 determines whether an operation end process has been executed. If the operation end process has not been executed (NO in step S525), then in step S526, the CPU 101 executes a previously specified process for a next job or a previous job. Then, the CPU 101 returns to step S520 to update the job execution information display screen. On the other hand, if the operation end process has been performed (YES in step S525), the CPU 101 performs a log-out process to end the series of processes.

In the above-described exemplary embodiment, the operation environment information unit 902 is configured to store operation environments for individual users, but the operation environment information unit 902 maybe used to store the operation environment for the image processing apparatus 100.

The user information management unit 901 and the operation environment management unit 902 are configured to be included in an external server, such as the user authentication server 201, but at least one of them may be mounted in the image processing apparatus 100.

According to the above-described exemplary embodiment, when a user logs into a job processing apparatus, if there is any job being executed or waiting to be executed, job execution information about a just-logged-in user is displayed on the screen. Accordingly, the user can easily recognize an execution status of the job. Then, if the user wants to stop or temporarily stop the job, the user can instantly execute a relevant process based on the job execution information.

As is understood from the above description, the CPU 101 illustrated in FIG. 1 functions as a job determination unit, a job status display control unit, an operation screen display control unit, a job confirmation unit, an abnormally-ended job display control unit, and a user authentication unit. The CPU 301 illustrated in FIG. 3 serves as a terminal operation screen display control unit and a job transmission unit.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-174566 filed Aug. 3, 2010, which is hereby incorporated by reference herein in its entirety.

What is claimed is:

1. A job processing apparatus for performing a job process for a job input by a user, the job processing apparatus comprising:
a job determination unit configured to determine whether there is a job being executed or waiting to be executed for a user when the user logs into the job processing apparatus; and
a job status display control unit configured to display a job execution information screen showing an execution status of the job being executed or waiting to be executed for the user when it is determined by the job determination unit that there is the job being executed or waiting to be executed.

2. The job processing apparatus according to claim 1, further comprising:
an operation screen display control unit configured to display an operation screen according to operation environment information managed for each user and showing each user's operation environment when it is determined by the job determination unit that there is no job being executed or waiting to be executed.

3. The job processing apparatus according to claim 2, further comprising:
a job confirmation unit configured to confirm whether there is a job unconfirmed by a logged-in user and ended abnormally when it is determined by the job determination unit that there is no job being executed or waiting to be executed,
wherein the operation screen display control unit displays the operation screen when it is confirmed by the job confirmation unit that there is no job unconfirmed by the logged-in user and ended abnormally.

4. The job processing apparatus according to claim 3, further comprising:
an abnormally-ended job display control unit configured to display an abnormally-ended job detail screen showing a detail of the abnormally-ended job when it is confirmed by the job confirmation unit that there is the job unconfirmed by the logged-in user and abnormally ended.

5. The job processing apparatus according to claim 1, further comprising:
a user authentication unit connected via a network to an authentication server configured to perform user authentication, the user authentication unit being configured to authenticate a user by sending user information to identify the user to the authentication server when the user information is input,
wherein, when the user is authenticated by the authentication server, the job determination unit sets the user as a logged-in user and determines whether there is a job being executed or waiting to be executed for the logged-in user.

6. The job processing apparatus according to claim 1, wherein the job processing apparatus is connected to an information processing apparatus via a network, and
wherein the information processing apparatus comprises:
a terminal operation display screen control unit configured to display a terminal operation screen according to operation environment information managed for each user and showing each user's operation environment when a user is authenticated when the information processing apparatus inputs a job into the job processing apparatus; and
a job transmission unit configured to assign to the job an identification code to identify the job and transmit the job to the job processing apparatus when a predetermined operation is performed on the terminal operation screen.

7. A method for controlling a job processing apparatus configured to execute a job process for a job input by a user, the method comprising:
determining whether there is a job being executed or waiting to be executed for a user when the user logs into the job processing apparatus; and
displaying a job execution information screen showing an execution status of the job being executed or waiting to be executed for the user when it is determined that there is the job being executed or waiting to be executed.

8. A non-transitory storage medium storing a program for causing a job processing apparatus to perform a control method, the job processing apparatus being configured to perform a job process for a job input by a user, the control method comprising:
determining whether there is a job being executed or waiting to be executed for a user when the user logs into the job processing apparatus; and
displaying a job execution information screen showing an execution status of the job being executed or waiting to be executed for the user when it is determined that there is the job being executed or waiting to be executed.

9. The method according to claim 7, further comprising:
displaying an operation screen according to operation environment information managed for each user and showing each user's operation environment when it is determined by the determining step that there is no job being executed or waiting to be executed.

10. The method according to claim 9, further comprising:
confirming whether there is a job unconfirmed by a logged-in user and ended abnormally when it is determined by the determining step that there is no job being executed or waiting to be executed,
wherein the displaying step displays the operation screen when it is confirmed by the confirming step that there is no job unconfirmed by the logged-in user and ended abnormally.

11. The method according to claim 10, further comprising:
displaying an abnormally-ended job detail screen showing a detail of the abnormally-ended job when it is confirmed by the confirming step that there is the job unconfirmed by the logged-in user and abnormally ended.

12. The method according to claim 7, further comprising:
authenticating a user by sending user information to identify the user to a authentication server when the user information is input,
wherein, when the user is authenticated by the authentication server, the determining step sets the user as a logged-in user and determines whether there is a job being executed or waiting to be executed for the logged-in user.
